(19) United States
(12) Patent Application Publication
(10) Pub. No.: US 2022/0098832 A1
(43) Pub. Date: Mar. 31, 2022

(54) Redundant Dual Pump Hydraulic System and Method for Electric Mining Machine

(71) Applicant: Artisan Vehicle Systems, Inc., Camarillo, CA (US)

(72) Inventors: Kyle Hickey, Moorpark, CA (US); Gaurav Mehta, Greater Sudbury (CA); Brian R. Huff, Newberry Park, CA (US); Christopher Vochoska, Simi Valley, CA (US)

(21) Appl. No.: 17/033,973

(22) Filed: Sep. 28, 2020

(51) Int. Cl. E02F 9/22; E02F 9/20

(52) U.S. Cl. CPC E02F 9/2242; E02F 9/0841; E02F 9/225; E02F 9/2091

(57) ABSTRACT

A hydraulic power distribution system and method for an electric mining machine is described. In one embodiment, the electric mining machine includes a first pump motor configured to drive a first hydraulic pump and a second pump motor configured to drive a second hydraulic pump. The electric mining machine further includes a first battery pack supplying electric power to the first pump motor and a second battery pack supplying electric power to the second pump motor. A hydraulic control system in communication with at least the first battery pack, the first pump motor, the first hydraulic pump, the second battery pack, the second pump motor, and the second hydraulic pump is configured to independently control each of the first hydraulic pump and the second hydraulic pump so that a combined hydraulic power output satisfies 100% of a hydraulic power output demand for the electric mining machine.

### BACKGROUND

The present disclosure relates broadly to electric machines and vehicles, and more specifically to electric machines and vehicles used in subsurface mines.

An overview of a sub-surface mine environment and general description of electric vehicles for mining is described in U.S. Pat. No. 9,994,117, issued on Jun. 12, 2018, titled “System And Method For Providing Power To A Mining Operation,” the entire contents of which are hereby incorporated by reference. The present disclosure relates heavy duty electric powered machines or vehicles that may operate in a continuous work environment such as a sub-surface mine. The battery packs employed in electric mining machines are heavy-duty, high powered battery packs which are comprised of multiple battery modules contained in a pack housing. Each module is comprised of multiple cells. The modules are equipped with an array of operational sensors and are provided with electronic components to provide data from the sensors to a separate maintenance network. Sensors can include temperature sensors, timing devices, charge level detection devices, and other monitoring devices which can be employed to provide an operations center with accurate, real-time data regarding the performance of the module and its performance history. Details of exemplary battery packs and battery management systems and the associated data generation and monitoring can be found in commonly owned U.S. Pat. No. 9,960,396 issued on May 1, 2018, titled “Module Backbone System;” and U.S. Pat. No. 10,063,069 issued on Aug. 28, 2018, titled “Module Maintenance System;” the entire contents of which are hereby incorporated by reference.

Earth-moving machinery, such as electric mining machines, are required to meet a variety of safety and performance criteria. For example, the International Organization for Standardization (ISO) sets forth steering requirements for wheeled machines in publication ISO 5010:2019 that requires that a machine travelling faster than 20 kph have an emergency steering power source. The steering system has to demonstrate an ability to navigate a 100 m long course with a 90 degree change of machine direction.

Meeting this requirement using conventional solutions can be very difficult, since a machine typically has only one engine to provide all mechanical and hydraulic power for the entire machine. Typical alternative solutions include using 24V powered motors that run small auxiliary pumps to provide an alternate energy supply that is independent of the engine. These systems are relatively low power, however, and result in poor emergency steering system performance.

There exists a need in the art for an improved system and method to address the drawbacks with the existing solutions.

### SUMMARY

A redundant dual pump hydraulic system and method for an electric mining machine are provided according to the techniques described herein.

In one aspect, a redundant dual pump hydraulic system for an electric mining machine is provided. The system includes a pair of hydraulic pumps having equal hydraulic power output capacities. Each hydraulic pump of the pair of hydraulic pumps has a maximum hydraulic output that provides more than 50% of a maximum total hydraulic power requirement for the electric mining machine. The combined hydraulic power output of the pair of hydraulic pumps is more than 100% of the maximum total hydraulic power requirement.

In another aspect, a method of hydraulic power distribution for an electric mining machine is provided. The method includes providing a pair of hydraulic pumps having equal hydraulic power output capacities. Each hydraulic pump of the pair of hydraulic pumps has a maximum hydraulic output that provides more than 50% of a maximum total hydraulic power requirement for the electric mining machine such that a combined hydraulic power output of the pair of hydraulic pumps is more than 100% of the maximum total hydraulic power requirement. The method also includes controlling each hydraulic pump of the pair of hydraulic pumps to provide a combined hydraulic power output to meet a total hydraulic output demand for the electric mining machine.

In another aspect, an electric mining machine is provided. The electric mining machine includes a first pump motor configured to drive a first hydraulic pump of the electric mining machine. The electric mining machine also includes a second pump motor configured to drive a second hydraulic pump of the electric mining machine. The electric mining machine further includes a first battery pack configured to supply electric power to the first pump motor and a second battery pack configured to supply electric power to the second pump motor. A hydraulic control system is in communication with at least the first battery pack, the first pump motor, the first hydraulic pump, the second battery pack, the second pump motor, and the second hydraulic pump. The hydraulic control system is configured to independently control each of the first hydraulic pump and the second hydraulic pump so that a combined hydraulic power output satisfies 100% of a hydraulic power output demand for the electric mining machine.

Other systems, methods, features and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is an isometric view of an example embodiment of an electric mining machine;

FIG. 2 is an outline view of the example embodiment of an electric mining machine illustrating components of redundant dual pump hydraulic system;

FIG. 3 is a schematic view of an example embodiment of a pair of hydraulic pumps for a redundant dual pump hydraulic system;

FIG. 4 is a schematic view of the components of the redundant dual pump hydraulic system of the electric mining machine;

FIG. 5 is a representative view of an example embodiment of maximum hydraulic power distribution in the electric mining machine;

FIG. 6 is a representative view of an example embodiment of hydraulic power distribution in the electric mining machine under hydraulic load;

FIG. 7 is a representative view of an example embodiment of a maximum hydraulic power output for a first hydraulic pump;

FIG. 8 is a representative view of an example embodiment of a maximum hydraulic power output for a second hydraulic pump;

FIG. 9 is a representative view of an example scenario of a hydraulic pump failure response by the redundant dual pump hydraulic system during a steering maneuver; and

FIG. 10 is a flowchart of an example embodiment of a method for hydraulic power distribution in an electric mining machine.

### DETAILED DESCRIPTION

Electric mining machines are generally powered by onboard battery packs. The machines can be load-haul-dump (LHD) machines, scalers, graders, scoops, rock breakers, cutters, haulers or a combination. In general, electric mining machines are heavy duty vehicles engineered for the challenging subsurface environments and limited spaces powered by an onboard battery or other power source. The machines generally include a tool end, heavy-duty wheels and tires, an operator area, controls, and may include a removable power source mounted onboard the machine.

This disclosure is directed to a redundant dual pump hydraulic system and method for an electric mining machine having two main battery packs that each supply electric power to separate hydraulic pumps and motors of the electric mining machine. According to the techniques described herein, the redundant dual pump hydraulic system and method distributes hydraulic power output between the two hydraulic pumps in order to meet hydraulic power load demand and to allow for a hydraulic pump failure response by using the output from a single hydraulic pump to continue to supply hydraulic power to the electric mining machine.

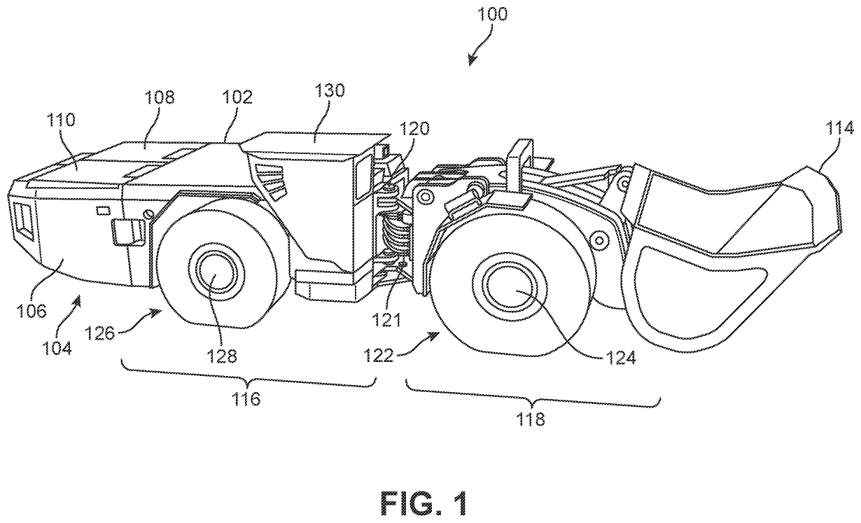

FIG. 1 illustrates an example embodiment of an electric mining machine 100. In one embodiment, electric mining machine 100 is a load-haul-dump (LHD) machine with a hauling capacity of approximately 18 metric tons. In other embodiments, however, the techniques of the present embodiments for hydraulic power output distribution may be applied to any type of electric mining machine or mining vehicle.

As shown in FIG. 1, in this embodiment, electric mining machine 100 includes a chassis 102 (or frame) that comprises the main body of electric mining machine 100. Chassis 102 is configured to engage with a removable power source 104 that provides electrical power to electric mining machine 100. Removable power source 104 includes a battery frame 106 that holds battery packs that provide the electrical power to electric mining machine 100. In this embodiment, removable power source 104 includes two battery packs, including a first battery pack 108 and a second battery pack 110. Each battery pack is a separate, self-contained battery pack that is configured to supply electric power to individual hydraulic pumps, as will be described below.

In an example embodiment, each of first battery pack 108 and second battery pack 110 may be a heavy-duty, high powered battery pack which is comprised of multiple battery modules contained in a pack housing. Each battery module (or module) is comprised of multiple battery cells (or cells). The modules are also equipped with an array of operational sensors and are provided with electronic components to provide data from the sensors to a separate maintenance network. Suitable battery modules and associated sensors and components are described in commonly owned U.S. Pat. Nos. 9,960,396 and 10,063,069, incorporated by reference above.

Removable power source 104 is removably attached to electric mining machine 100. As used herein, the term “removably attached” refers to two components that are joined together but that can be separated without destroying one or the other component. That is, the components can be non-destructively detached from one another. Exemplary modalities of “removable attachment” include connections made using removable fasteners, latches, locks, hooks, magnetic connections as well as other kinds of connections.

In this embodiment, removable power source 104 is removably attached to chassis 102 at the rear of electric mining machine 100. For example, an attachment mechanism (not shown) may be configured to engage a portion of battery frame 106 of removable power source 104 using a plurality of hooks. It should be understood that other types of attachment mechanisms may be used to attach removable power source 104 to electric mining machine 100. Additionally, in other embodiments, the attachment location of removable power source 104 on electric mining machine 100 may also be different.

In an example embodiment, electric mining machine 100 is an LHD and includes a bucket 114 at the front of electric mining machine 100. In other embodiments, however, the electric mining machine may be any type of electric mining machine or electric vehicle. In these embodiments, the electric mining machine may be equipped with different mechanisms depending on its function. That is, bucket 114 is optional and is not required to implement the techniques of the example embodiments.

In some embodiments, chassis 102 comprising the main body of electric mining machine 100 may include a first body portion 116 and a second body portion 118. First body portion 116 may be a rearward portion of electric mining machine 100. Second body portion 118 may be a frontward portion of electric mining machine 100. In some embodiments, a mechanical linkage 120 connects first body portion 116 and second body portion 118 so that the two portions can move relative to one another (e.g., swivel or pivot). In an example embodiment, a plurality of hydraulic lines 121 extend between first body portion 116 and second body portion 118 at mechanical linkage 120. Plurality of hydraulic lines 121 are configured to supply hydraulic fluid to one or more components of a redundant dual pump hydraulic system, as will be described below.

In an example embodiment, electric mining machine 100 includes a propulsion system comprising one or more electric motors that are powered by one or more batteries. In some embodiments, electric mining machine 100 may include at least two electric motors for powering each set of wheels. For example, in this embodiment, electric mining machine 100 includes a first set of wheels 122 located on second body portion 118 associated with the frontward portion of electric mining machine 100. First set of wheels 122 are connected to a front axle 124 that is powered by a front electric motor. In this embodiment, electric mining machine 100 also includes a second set of wheels 126 located on first body portion 116 associated with the rearward portion of electric mining machine 100. Second set of wheels 126 are connected to a rear axle 128 that is powered by a rear electric motor.

In an example embodiment, each set of wheels (e.g., first set of wheels 122 and second set of wheels 126) may comprise a pair of wheels on each side of electric mining machine 100 (i.e., one wheel per side). In other embodiments, additional wheels may be provided on one or both axles. For example, in some cases, one or both of front axle 124 or rear axle 128 may include two wheels on each side of electric mining machine 100.

In one embodiment, front axle 124 and rear axle 128 are not mechanically linked. In other words, each axle may be independently powered by its associated electric motor. In this manner, first set of wheels 122 on front axle 124 and second set of wheels 126 on rear axle 128 can be driven at different speeds and/or provided with different amounts of power.

In some embodiments, electric mining machine 100 may include additional components, including various standard vehicular provisions and accessories. For example, as shown in FIG. 1, electric mining machine 100 includes a cab 130 for receiving one or more operators of electric mining machine 100. Other typical components of a mining machine may also be provided.

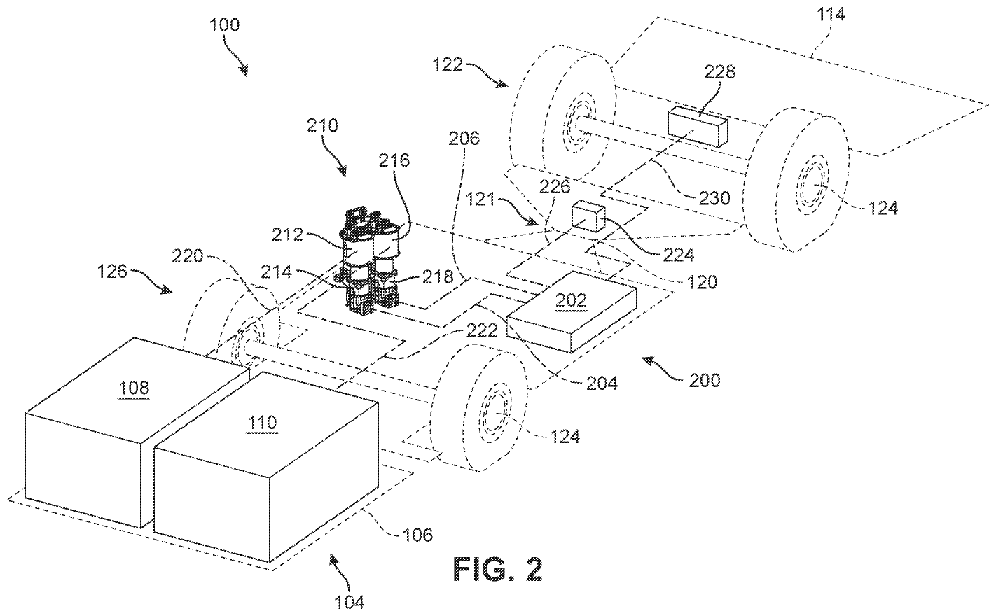

Referring now to FIG. 2, an outline view of electric mining machine 100 is shown to illustrate the components of a redundant dual pump hydraulic system 200. In an example embodiment, redundant dual pump hydraulic system 200 includes a hydraulic control system 202 configured to control operation of the various components of redundant dual pump hydraulic system 200. For example, hydraulic control system 202 may be in fluid communication with a pair of hydraulic pumps 210, including a first hydraulic pump 212 and a second hydraulic pump 216.

First hydraulic pump 212 may be in fluid communication with hydraulic control system 202 via a first hydraulic supply line 204 and second hydraulic pump 216 may be in fluid communication with hydraulic control system 202 via a second hydraulic supply line 206. With this arrangement, hydraulic control system 202 may use pressurized hydraulic fluid received from first hydraulic pump 212 and/or second hydraulic pump 216 to operate one or more components, including, for example, a steering system 224 (via a first hydraulic output line 226) and/or a lifting and loading system 228 (via a second hydraulic output line 230).

In some embodiments, each battery pack of removable power source 104 (i.e., first battery pack 108 and second battery pack 110) may supply electric power to a different hydraulic pump (and its associated pump motor) of pair of hydraulic pumps 210, including first hydraulic pump 212 and second hydraulic pump 216. For example, in this embodiment, first battery pack 108 supplies electric power a first pump motor 214 that drives first hydraulic pump 212. Similarly, second battery pack 110 supplies electric power to a second pump motor 218 that drives second hydraulic pump 216.

In one embodiment, as shown in FIG. 2, first battery pack 108 may be connected via a power cable 220 to provide power to first hydraulic pump 212 and first pump motor 214. Likewise, second battery pack 110 may be connected via a power cable 222 to provide power to second hydraulic pump 216 and a second pump motor 218.

It should be understood that first battery pack 108 and second battery pack 110 may also supply electric power to other components of electric mining machine 100, including, for example, one or more motors that are configured to move first set of wheels 122 on front axle 124 and/or second set of wheels 126 on rear axle 128. Additionally, first battery pack 108 and second battery pack 110 may supply electric power to other components of electric mining machine 100, including hydraulic control system 202, steering system 224, lifting and loading system 228, and various accessories, such as lights, sensors, communications, displays, etc.

By powering each hydraulic pump of pair of hydraulic pumps 210 using separate battery packs (e.g., first battery pack 108 powering first hydraulic pump 212 and second battery pack 110 powering second hydraulic pump 216), the amount of power to be delivered to a single source is reduced. This allows for load balancing between each hydraulic pump to control how much power is being used to better manage the remaining charge of each battery pack. Additionally, as will be described below, each hydraulic pump is configured to independently provide more than 50% of a maximum total hydraulic power requirement for the electric mining machine so that the combined hydraulic power output of the pair of hydraulic pumps is more than 100% of the maximum total hydraulic power requirement of the electric mining machine.

For example, in one embodiment, each hydraulic pump of pair of hydraulic pumps 210 is configured to provide approximately 75% of the maximum total hydraulic power requirement for electric mining machine 100. Thus, in the event of a failure (e.g., failure of a battery pack, pump motor, and/or hydraulic pump) the remaining hydraulic pump can supply up to 75% of the maximum total hydraulic power requirement for electric mining machine 100 to maintain normal operation parameters, including, for example, steering requirements.

In an example embodiment, pair of hydraulic pumps 210 may be located behind cab 130 on main body or chassis 102 of electric mining machine 100. In this embodiment, pair of hydraulic pumps 210 are arranged together (i.e., adjacent to one another). However, in other embodiments, each individual hydraulic pump of pair of hydraulic pumps 210 (e.g., first hydraulic pump 212 and second hydraulic pump 216) may be arranged in different locations on main body or chassis 102 of electric mining machine 100. For example, in one embodiment, each individual hydraulic pump of pair of hydraulic pumps 210 (e.g., first hydraulic pump 212 and second hydraulic pump 216) may be arranged on opposite sides of electric mining machine 100. In other embodiments, the arrangement of each individual hydraulic pump within the electric mining machine may vary based on space and layout requirements and specifications. By using two individual hydraulic pumps, which are each smaller in size than a conventional single hydraulic pump, flexibility in the arrangement of the hydraulic pumps within the main body or chassis 102 of electric mining machine 100 can be provided.

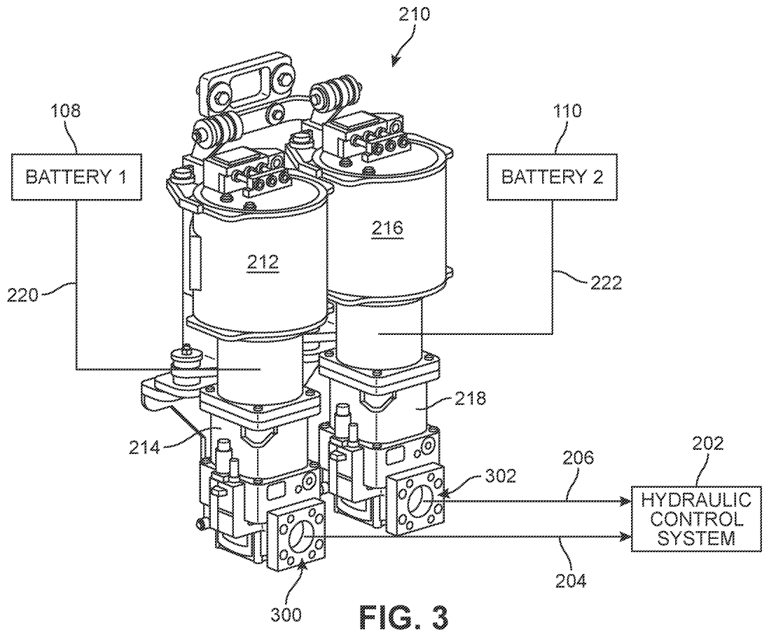

Referring now to FIG. 3, a schematic view of the components of pair of hydraulic pumps 210 of redundant dual pump hydraulic system 200 of electric mining machine 100 are illustrated. In this embodiment, pair of hydraulic pumps 210, including first hydraulic pump 212 and second hydraulic pump 216, may be seen in detail. As shown in FIG. 3, a first outlet 300 of first hydraulic pump 212 is in fluid communication with hydraulic control system 202 via first hydraulic supply line 204. First battery pack 108 supplies electric power through power cable 220 to provide power to first pump motor 214 to drive first hydraulic pump 212 to cause hydraulic fluid within first hydraulic pump 212 to become pressurized. With this arrangement, pressurized hydraulic fluid from first hydraulic pump 212 may flow from first outlet 300 through first hydraulic supply line 204 to hydraulic control system 202.

Similarly, a second outlet 302 of second hydraulic pump 216 is in fluid communication with hydraulic control system 202 via second hydraulic supply line 206. Second battery pack 110 supplies electric power through power cable 222 to provide power to second pump motor 218 to drive second hydraulic pump 216 to cause hydraulic fluid within second hydraulic pump 216 to become pressurized. With this arrangement, pressurized hydraulic fluid from second hydraulic pump 216 may flow from second outlet 302 through second hydraulic supply line 206 to hydraulic control system 202.

Conventional hydraulic systems typically use a single hydraulic pump that is configured or rated to supply 100% of the maximum total hydraulic power requirement for the mining vehicle. In contrast, as described above, each individual hydraulic pump (e.g., first hydraulic pump 212 and second hydraulic pump 216) of pair of hydraulic pumps 210 is configured to independently provide more than 50% of a maximum total hydraulic power requirement for electric mining machine 100 so that the combined hydraulic power output of pair of hydraulic pumps 210 is more than 100% of the maximum total hydraulic power requirement of electric mining machine 100. In some embodiments, each individual hydraulic pump is configured to provide between 70%-80% of the maximum total hydraulic power requirement for electric mining machine 100.

In one embodiment, each individual hydraulic pump (e.g., first hydraulic pump 212 and second hydraulic pump 216) of pair of hydraulic pumps 210 is configured to independently provide approximately 75% of the maximum total hydraulic power requirement for electric mining machine 100. That is, the combined maximum output of pressurized hydraulic fluid from first outlet 300 and second outlet 302 to hydraulic control system 202 may be 150% of the maximum total hydraulic power requirement for electric mining machine 100 (measured, for example, in terms of volume output or flow rate).

Accordingly, the redundant dual pump hydraulic system and method according to the techniques of the embodiments described herein can load balance the hydraulic fluid output between the individual hydraulic pump (e.g., first hydraulic pump 212 and second hydraulic pump 216) in order to meet a hydraulic load demand. With this arrangement, the dual pump configuration provided by pair of hydraulic pumps 210 provides redundancy in the event of a failure. Additionally, because each individual hydraulic pump is connected to an independent battery pack (e.g., first battery pack 108 powering first pump motor 214 of first hydraulic pump 212 and second battery pack 110 powering second pump motor 218 of second hydraulic pump 216), unequal load and/or discharge rates between first battery pack 108 and second battery pack 110 may be compensated for to better distribute the electric power load and/or discharge rates between each battery pack by increasing or decreasing the respective loads of the associated hydraulic pump.

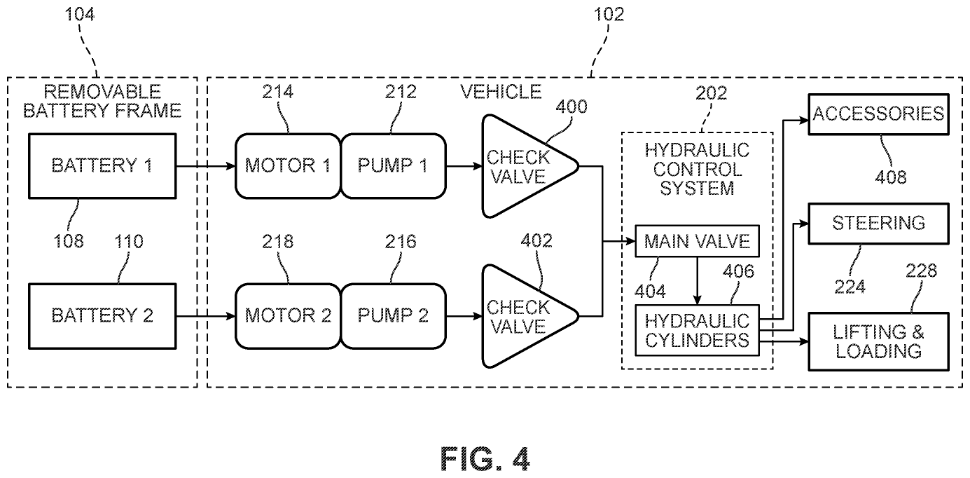

Referring now to FIG. 4, components of redundant dual pump hydraulic system 200 are shown. In an example embodiment, redundant dual pump hydraulic system 200 is located on main body or chassis 102 of electric mining machine 100. Electric power for redundant dual pump hydraulic system 200 is provided by removable power source 104 containing first battery pack 108 and second battery pack 110, which may be removable from main body or chassis 102 of electric mining machine 100, as described above, to facilitate being replaced with another substantially similar removable power source containing two individual battery packs.

As described above, first battery pack 108 supplies electric power to first pump motor 214 that drives first hydraulic pump 212 to pressurize hydraulic fluid, which exits first hydraulic pump 212 through first outlet 300 via first hydraulic supply line 204 (shown in FIG. 3) and then passes through a first check valve 400 before reaching hydraulic control system 202. Similarly, second battery pack 110 supplies electric power to second pump motor 218 that drives second hydraulic pump 216 to pressurize hydraulic fluid, which exits second hydraulic pump 216 through second outlet 302 via second hydraulic supply line 206 (shown in FIG. 3) and then passes through a second check valve 402 before reaching hydraulic control system 202.

At hydraulic control system 202, pressurized hydraulic fluid from each of first hydraulic pump 212 and second hydraulic pump 216 is collected at a main valve 404. Main valve 404 may receive instructions from hydraulic control system 202, for example, from a processor or other computerized controller, to release the pressurized hydraulic fluid from main valve 404 through one or more hydraulic cylinders 406. For example, hydraulic cylinders 406 may be associated with various hydraulic system components, including, but not limited to steering system 224 and/or lifting and loading system 228.

In an example embodiment, steering system 224 may use hydraulic actuators to pivot or swivel first body portion 116 and second body portion 118 around mechanical linkage 120 to control a steering angle or direction of electric mining machine 100. In an example embodiment, lifting and loading system 228 may use hydraulic actuators to control operation of bucket 114 at the front of electric mining machine 100 (i.e., lifting, tilting, etc.).

It should also be understood that redundant dual pump hydraulic system 200 may include other conventional components, including, but not limited to return hydraulic supply lines that provide hydraulic fluid back to pair of hydraulic pumps 210 and a reservoir or other tanks that are configured to hold or store hydraulic fluid.

In addition, electric mining machine 100 may include one or more hydraulic accessories 408 that may use hydraulic fluid from redundant dual pump hydraulic system 200, such as, for example, braking systems, power-take off systems, etc. Additionally, in some embodiments, electric mining machine 100 may include other components conventionally associated with mining vehicles or other types of earth moving machines.

In this embodiment, accessories 408 may be supplied electric power from first battery pack 108. Thus, in some embodiments, first battery pack 108 supplies electric power not only to first hydraulic pump 212 and first pump motor 214, as well as to an electric motor to drive front axle 124, but also to accessories 408. As a result, in these embodiments, first battery pack 108 may experience higher loads or discharging rates than second battery pack 110, which only supplies electric power to second hydraulic pump 216 and second pump motor 218, as well as to an electric motor to drive rear axle 128. In other embodiments, accessories 408 may be supplied electric power from second battery pack 110 instead of first battery pack 108.

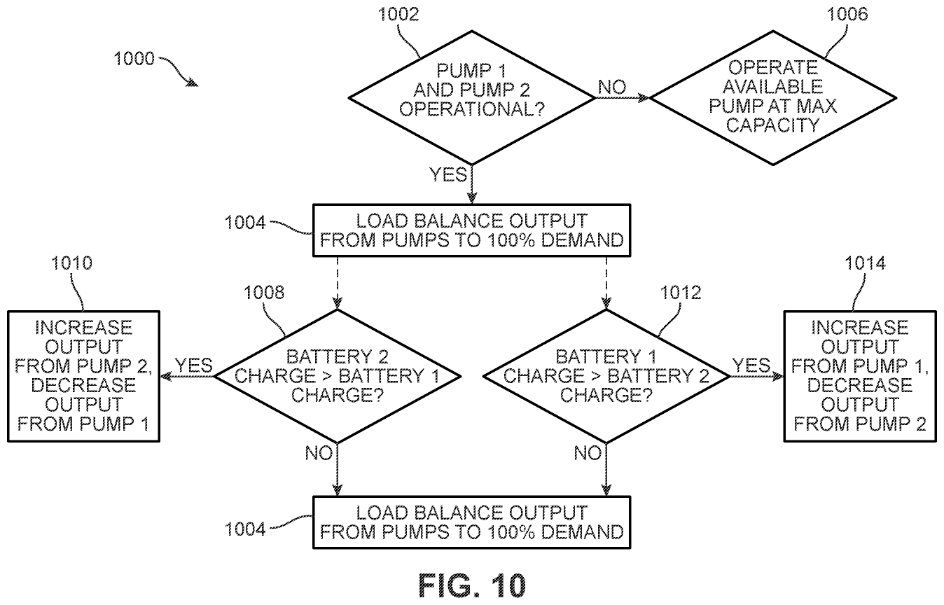

As will be described below in reference to FIG. 10, these unequal load and/or discharge rates between first battery pack 108 and second battery pack 110 may be compensated for to better distribute the electric power load and/or discharge rates between each battery pack by increasing or decreasing the respective hydraulic loads of the associated hydraulic pump.

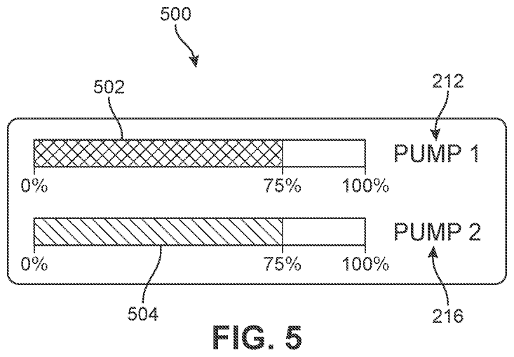

Referring now to FIGS. 5-9, example scenarios of hydraulic power distribution for electric mining machine 100 according to the techniques of the present embodiments are illustrated. FIG. 5 illustrates an example embodiment of a maximum hydraulic power distribution 500 in electric mining machine 100 for each of first hydraulic pump 212 and second hydraulic pump 216. As shown in FIG. 5, maximum hydraulic power distribution 500 includes a first maximum hydraulic power output 502 from first hydraulic pump 212 that is approximately 75% of the maximum total hydraulic power requirement for electric mining machine 100 (i.e., indicated at 100% in FIG. 5). Maximum hydraulic power distribution 500 also includes a second maximum hydraulic power output 504 from second hydraulic pump 216 that is also approximately 75% of the maximum total hydraulic power requirement for electric mining machine 100. Accordingly, the combined maximum output of pressurized hydraulic fluid from first hydraulic pump 212 and second hydraulic pump 216 may be 150% of the maximum total hydraulic power requirement for electric mining machine 100 (measured, for example, in terms of volume output or flow rate).

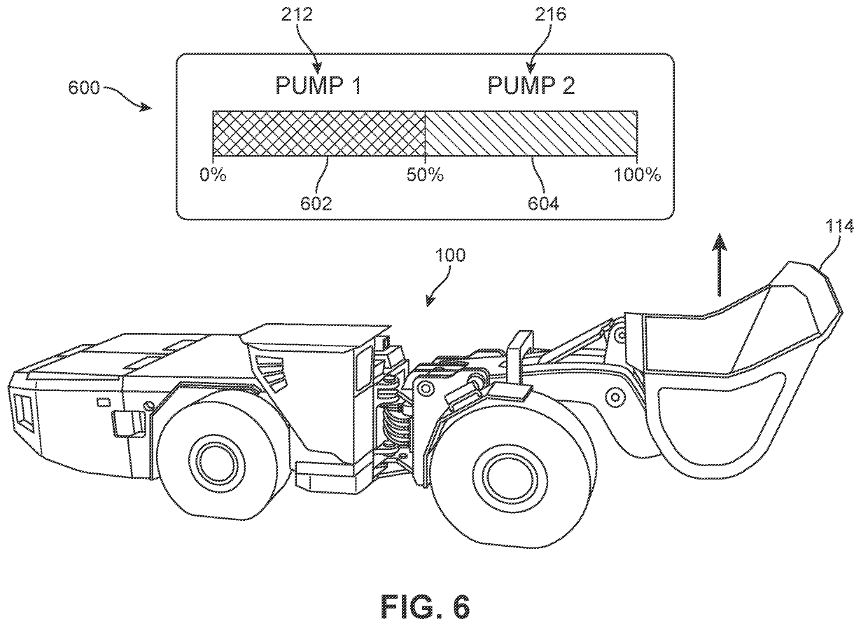

During normal operation of electric mining machine 100, hydraulic power distribution may be load balanced between first hydraulic pump 212 and second hydraulic pump 216 so that neither hydraulic pump is required to operate at its maximum capacity (i.e., 502, 504). For example, FIG. 6 is a representative view of an example embodiment of a load-balanced hydraulic power distribution 600 in electric mining machine 100 under hydraulic load. In this embodiment, electric mining machine 100 is performing normal operations, for example, raising bucket 114 using loading and lifting system 228, described above. Raising bucket 114 requires a certain amount of hydraulic power to drive the hydraulic actuators of loading and lifting system 228. In order to meet this amount of hydraulic power, hydraulic control system 202 may instruct each of first hydraulic pump 212 and second hydraulic pump 216 to provide approximately 50% of the total hydraulic power output.

Accordingly, as shown in FIG. 6, load-balanced hydraulic power distribution 600 is evenly distributed between a first output 602 from first hydraulic pump 212 (e.g., providing approximately 50% of the total) and a second output 604 from second hydraulic pump 216 (e.g., providing approximately 50% of the total) so that the entire hydraulic power output required to drive the hydraulic actuators of loading and lifting system 228 to raise bucket 114 is met by the combined output of first hydraulic pump 212 and second hydraulic pump 216. With this arrangement, the hydraulic power output can be evenly distributed between each hydraulic pump and the corresponding load and/or discharge rates between first battery pack 108 and second battery pack 110 (e.g., first battery pack 108 powering first pump motor 214 of first hydraulic pump 212 and second battery pack 110 powering second pump motor 218 of second hydraulic pump 216) may also be evenly distributed between each battery pack.

While the example embodiment of load-balanced hydraulic power distribution 600 illustrates first output 602 and second output 604 that are both approximately 50% of the total required hydraulic power output, other proportional load distributions may be provided between first hydraulic pump 212 and second hydraulic pump 216 by hydraulic control system 202.

In some embodiments the output of one hydraulic pump of pair of hydraulic pumps 210 may be controlled by hydraulic control system 202 to be less than the output of the other. For example, in one embodiment, the output of first hydraulic pump 212 may be controlled to be less than the output of second hydraulic pump 216 in order to compensate for a greater electrical load or discharge rate on first battery pack 108. In this case, the hydraulic power distribution may be split 40:60 (e.g., first output 602 from first hydraulic pump 212 provides approximately 40% of the total required hydraulic power output and second output 604 from second hydraulic pump 216 provides approximately 60% of the total required hydraulic power output). With this arrangement, proportional load balancing between first hydraulic pump 212 and second hydraulic pump 216 may be provided. It should be understood that in other embodiments, other proportional splits may be provided between first hydraulic pump 212 and second hydraulic pump 216 so that the resulting total required hydraulic power output is met by the combined outputs 602, 604.

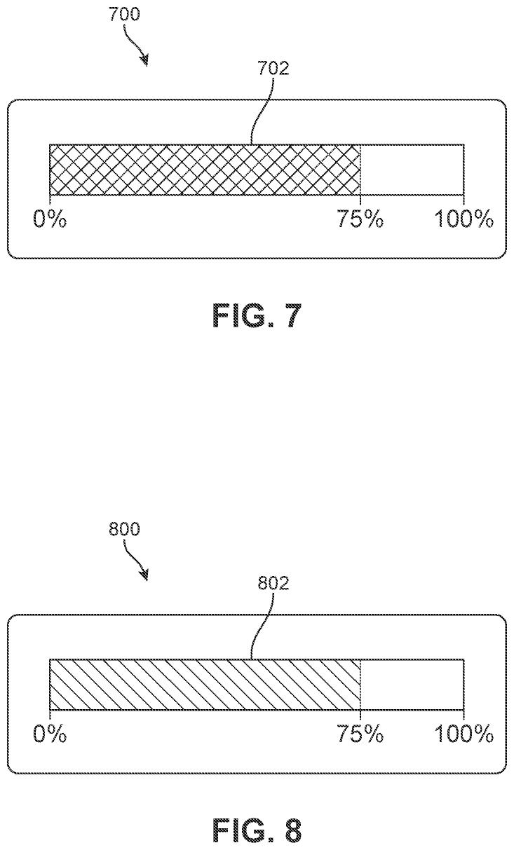

FIG. 7 illustrates a hydraulic power distribution 700 for first hydraulic pump 212 working alone. In this embodiment, only one hydraulic pump of pair of hydraulic pumps 210 is available to electric mining machine 100 (e.g., first hydraulic pump 212). For example, hydraulic power distribution 700 from only first hydraulic pump 212 may occur in the event of a failure of a component, such as a failure of second hydraulic pump 216, a failure of second battery pack 110 supplying electric power to second hydraulic pump 216, and/or a failure of second pump motor 218 that drives second hydraulic pump 216. In other cases, hydraulic control system 202 may operate only first hydraulic pump 212 because of a high electrical load or discharge rate experienced by second battery pack 110. In still other cases, hydraulic control system 202 may operate only first hydraulic pump 212 in order to deplete a charge level of first battery pack 108 to equalize with second battery pack 110 (i.e., load balancing for charge distribution). In these circumstances, a maximum hydraulic power output 702 from first hydraulic pump 212 is approximately 75% of the maximum total hydraulic power requirement for electric mining machine 100, measured, for example, in terms of volume output or flow rate.

FIG. 8 illustrates a hydraulic power distribution 800 for second hydraulic pump 216 working alone. In this embodiment, only one hydraulic pump of pair of hydraulic pumps 210 is available to electric mining machine 100 (e.g., second hydraulic pump 216). For example, hydraulic power distribution 800 from only second hydraulic pump 216 may occur in the event of a failure of a component, such as a failure of first hydraulic pump 212, a failure of first battery pack 108 supplying electric power to first hydraulic pump 212, and/or a failure of first pump motor 214 that drives first hydraulic pump 212. In other cases, hydraulic control system 202 may operate only first hydraulic pump 212 because of a high electrical load or discharge rate experienced by first battery pack 108. In still other cases, hydraulic control system 202 may operate only second hydraulic pump 216 in order to deplete a charge level of second battery pack 110 to equalize with first battery pack 108 (i.e., load balancing for charge distribution). In these circumstances, a maximum hydraulic power output 802 from second hydraulic pump 216 is approximately 75% of the maximum total hydraulic power requirement for electric mining machine 100, measured, for example, in terms of volume output or flow rate.

Under normal operating conditions, 75% of the maximum total hydraulic power requirement for electric mining machine 100 will be sufficient to operate electric mining machine 100 without a significant reduction in performance or capabilities. That is, electric mining machine 100 does not always need to be operated at the maximum total hydraulic power requirement (i.e., 100%) for most tasks. For example, at 75% of the maximum total hydraulic power requirement for electric mining machine 100, the hauling capacity of approximately 18 metric tons may be reduced to 13.5 metric tons (e.g., 75%), which allows an operator to continue to use electric mining machine 100 at this reduced capacity without requiring that electric mining machine 100 be taken out of service. With this arrangement, maximum hydraulic power output 702 from first hydraulic pump 212 or maximum hydraulic power output 802 from second hydraulic pump 216 is sufficient to continue to operate electric mining machine 100 without a significant reduction in performance or capabilities.

Additionally, maximum hydraulic power output 702 from first hydraulic pump 212 or maximum hydraulic power output 802 from second hydraulic pump 216 also allows other components of redundant dual pump hydraulic system 200 to remain operational and function substantially within normal operating conditions, such as steering system 224, lifting and loading system 228, and/or one or more accessories 408. For example, either of maximum hydraulic power output 702 from first hydraulic pump 212 or maximum hydraulic power output 802 from second hydraulic pump 216 allows for electric mining machine 100 to conduct steering maneuvers in accordance with the requirements of ISO 5010:2019, described above.

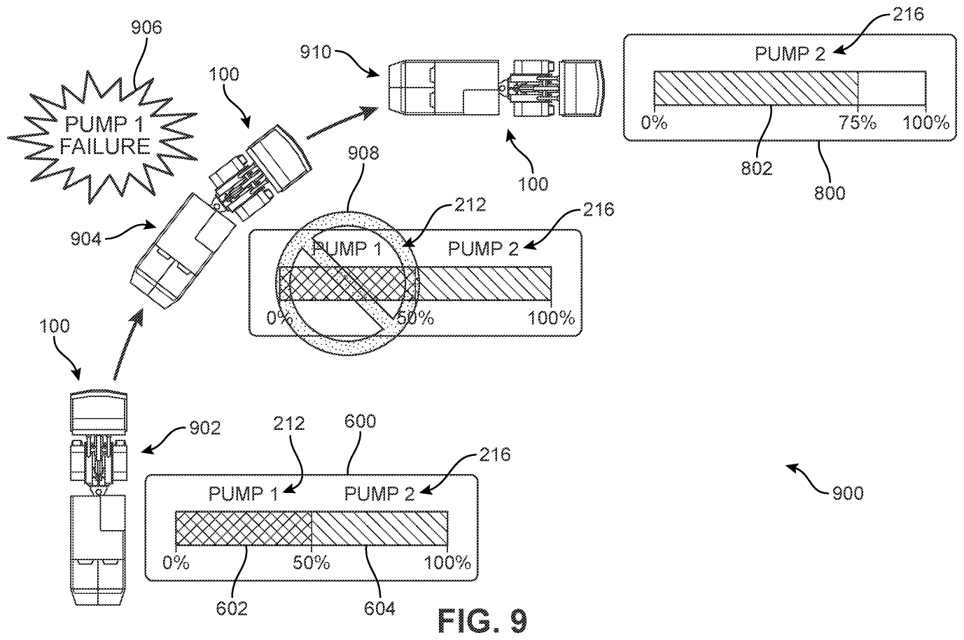

Referring now to FIG. 9, an example scenario of a hydraulic pump failure response 900 by redundant dual pump hydraulic system 200 during a steering maneuver is illustrated. In this embodiment, electric mining machine 100 begins a steering maneuver at a step 902. During the beginning of the steering maneuver at step 902, redundant dual pump hydraulic system 200 is undergoing load-balanced hydraulic power distribution 600 where hydraulic power output for electric mining machine 100 is evenly distributed between first output 602 from first hydraulic pump 212 (e.g., providing approximately 50% of the total) and second output 604 from second hydraulic pump 216 (e.g., providing approximately 50% of the total), as described above.

Next, at a step 904, electric mining machine 100 is in the middle of the steering maneuver. During step 904, one hydraulic pump of pair of hydraulic pumps 210 experiences a failure event 906. For example, in this embodiment, first hydraulic pump 212 experiences failure event 906. Failure event 906 may include a failure of first hydraulic pump 212 or a failure of any of the associated components that operate first hydraulic pump 212, such as first battery pack 108 and/or first pump motor 216, as described above. As a result of failure event 906, first output 602 from first hydraulic pump 212 goes to zero, as indicated by indicator 908 (i.e., first hydraulic pump 212 is no longer operable to provide a hydraulic power output).

According to the techniques of the present embodiments described herein, the remaining hydraulic pump, second hydraulic pump 216, may be controlled by hydraulic control system 202 to independently provide approximately 75% of the maximum total hydraulic power requirement for electric mining machine 100. For example, at a step 910, electric mining machine 100 is able to complete the steering maneuver after failure event 906 of first hydraulic pump 212 using maximum hydraulic power output 802 from second hydraulic pump 216.

With this configuration, redundant dual pump hydraulic system 200 implements hydraulic pump failure response 900 in a manner that is sufficient to continue to operate electric mining machine 100 without a significant reduction in performance or capabilities, for example, steering capability in this example scenario. It should be understood that a similar failure response may also be implemented in the event of a failure of second hydraulic pump 216 (e.g., using maximum hydraulic power output 702 from first hydraulic pump 212).

Referring now to FIG. 10, a flowchart of an example embodiment of a method 1000 for hydraulic power distribution in an electric mining machine is illustrated. In an example embodiment, method 1000 may be implemented by a processor of a hydraulic control system, for example, hydraulic control system 202 of redundant dual pump hydraulic system 200, described above. In this embodiment, method 1000 may begin at an operation 1002. At operation 1002, whether or both hydraulic pumps of pair of hydraulic pumps 210 are currently operational. For example, at operation 1002 hydraulic control system 202 determines whether either of first hydraulic pump 212 or second hydraulic pump 216 has experienced a failure event (e.g., failure event 906 illustrated in FIG. 9).

Upon determining that both hydraulic pumps are operational at operation 1002, then method 1000 proceeds to an operation 1004. At operation 1004, the output from both hydraulic pumps is load balanced to combine to provide 100% of the required hydraulic power demand for electric mining machine 100. For example, as described above in reference to FIG. 6.

Upon determining that one hydraulic pump is not operational at operation 1002, then method 1000 proceeds to an operation 1006. At operation 1006, method 1000 includes operating the remaining available hydraulic pump at its maximum capacity (e.g., either of maximum hydraulic power output 702 from first hydraulic pump 212 or maximum hydraulic power output 802 from second hydraulic pump 216). As detailed above, the maximum output from a single hydraulic pump is sufficient to continue to operate electric mining machine 100 without a significant reduction in performance or capabilities.

In some embodiments, method 1000 further include optional or additional operations that allows hydraulic control system 202 to compensated for unequal load and/or discharge rates between first battery pack 108 and second battery pack 110 by increasing or decreasing the respective loads of the associated hydraulic pump. At an operation 1008, the state of charge of the two battery packs (e.g., first battery pack 108 and second battery pack 110) are compared. For example, at operation 1008, a state of charge of the second battery pack (e.g., second battery pack 110) that supplies electric power to second pump motor 218 to drive second hydraulic pump 216 is compared to a state of charge of the first battery pack (e.g., first battery pack 108) that supplies electric power to first pump motor 214 to drive first hydraulic pump 212. Operation 1008 determines whether or not the state of charge of the second battery pack is greater than the state of charge of the first battery pack.

Upon determining at operation 1008 that the state of charge of the second battery pack is greater than the state of charge of the first battery pack, method 1000 proceeds to an operation 1010. At operation 1010, the hydraulic output from second hydraulic pump 216 is increased, which causes second pump motor 218 to use an increased amount of electric power from second battery pack 110 and the hydraulic output from first hydraulic pump 212 is decreased, which causes first pump motor 214 to use a decreased amount of electric power from first battery pack 108.

Similarly, at operation 1012, a state of charge of the first battery pack (e.g., first battery pack 108) that supplies electric power to first pump motor 214 to drive first hydraulic pump 212 is compared to a state of charge of the second battery pack (e.g., second battery pack 110) that supplies electric power to second pump motor 218 to drive second hydraulic pump 216. Operation 1012 determines whether or not the state of charge of the first battery pack is greater than the state of charge of the second battery pack.

Upon determining at operation 1012 that the state of charge of the first battery pack is greater than the state of charge of the second battery pack, method 1000 proceeds to an operation 1014. At operation 1014, the hydraulic output from first hydraulic pump 212 is increased, which causes first pump motor 214 to use an increased amount of electric power from first battery pack 108 and the hydraulic output from second hydraulic pump 216 is decreased, which causes second pump motor 218 to use a decreased amount of electric power from second battery pack 110.

Accordingly, because of the increase in power to first pump motor 214 (and/or the decrease in power to second pump motor 218), more charge is depleted from the first battery pack (e.g., first battery pack 108) than the second battery pack (e.g., second battery pack 110). With this arrangement, method 1000 may be used to equalize the amount of charge of remaining between the two main battery packs (e.g., first battery pack 108 and second battery pack 110).

Upon determining at either operation 1008 or operation 1012 that there is no imbalance between the state of charge of the battery packs (i.e., the state of charge of first battery pack 108 is approximately the same as second battery pack 110), then method 1000 proceeds to operation 1004 where the output from both hydraulic pumps is load balanced to combine to provide 100% of the required hydraulic power demand for electric mining machine 100, as described above.

With this arrangement, method 1000 for hydraulic power distribution may be used to equalize the amount of charge of remaining between the two main battery packs (e.g., first battery pack 108 and second battery pack 110) of an electric mining machine (e.g., electric mining machine 100).

While various embodiments of the invention have been described, the description is intended to be exemplary, rather than limiting and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

1. A redundant dual pump hydraulic system for an electric mining machine, the system comprising:
a pair of hydraulic pumps having equal hydraulic power output capacities, wherein each hydraulic pump of the pair of hydraulic pumps has a maximum hydraulic output that provides more than 50% of a maximum total hydraulic power requirement for the electric mining machine; and
wherein the combined hydraulic power output of the pair of hydraulic pumps is more than 100% of the maximum total hydraulic power requirement.

2. The system according to claim 1, wherein the maximum hydraulic output of each hydraulic pump of the pair of hydraulic pumps provides 75% of the maximum total hydraulic power requirement for the electric mining machine such that the combined hydraulic power output of the pair of hydraulic pumps is 150% of the maximum total hydraulic power requirement.

3. The system according to claim 1, further comprising:
a first battery pack and a second battery pack configured to supply electric power to the electric mining machine;
the first battery pack configured to supply electric power to a first pump motor to drive a first hydraulic pump of the pair of hydraulic pumps; and
the second battery pack configured to supply electric power to a second pump motor to drive a second hydraulic pump of the pair of hydraulic pumps.

4. The system according to claim 3, further comprising:
a hydraulic control system including at least one processor;
wherein the hydraulic control system is configured to independently control each of the first hydraulic pump and the second hydraulic pump so that a combined hydraulic power output satisfies 100% of a hydraulic power output demand for the electric mining machine.

5. The system according to claim 4, wherein the hydraulic control system is configured to increase or decrease a hydraulic power output from one of the first hydraulic pump or the second hydraulic pump to balance an amount of charge of one of the first battery pack or the second battery pack.

6. The system according to claim 4, wherein upon an occurrence of a failure event associated with one of the first hydraulic pump and the second hydraulic pump, the hydraulic control system is configured to operate the remaining one of the first hydraulic pump and the second hydraulic pump at its maximum hydraulic output to maintain operation of the redundant dual pump hydraulic system.

7. The system according to claim 1, wherein the electric mining machine is configured to operate using only the maximum hydraulic power output from one hydraulic pump of the pair of hydraulic pumps.

8. The system according to claim 7, further comprising a steering system; and
wherein the maximum hydraulic power output from the one hydraulic pump of the pair of hydraulic pumps is sufficient to control the steering system.

9. A method of hydraulic power distribution for an electric mining machine, the method comprising:
providing a pair of hydraulic pumps having equal hydraulic power output capacities, wherein each hydraulic pump of the pair of hydraulic pumps has a maximum hydraulic output that provides more than 50% of a maximum total hydraulic power requirement for the electric mining machine such that a combined hydraulic power output of the pair of hydraulic pumps is more than 100% of the maximum total hydraulic power requirement; and
controlling each hydraulic pump of the pair of hydraulic pumps to provide a combined hydraulic power output to meet a total hydraulic output demand for the electric mining machine.

10. The method according to claim 9, further comprising:
controlling each hydraulic pump of the pair of hydraulic pumps to provide the same hydraulic power output.

11. The method according to claim 9, wherein the maximum hydraulic output of each hydraulic pump of the pair of hydraulic pumps provides 75% of the maximum total hydraulic power requirement for the electric mining machine such that the combined hydraulic power output of the pair of hydraulic pumps is 150% of the maximum total hydraulic power requirement.

12. The method according to claim 9, wherein the electric mining machine further comprises a first battery pack and a second battery pack configured to supply electric power to the electric mining machine;
the method further comprising:
supplying electric power from the first battery pack to a first pump motor to drive a first hydraulic pump of the pair of hydraulic pumps; and
supplying electric power from the second battery to a second pump motor to drive a second hydraulic pump of the pair of hydraulic pumps.

13. The method according to claim 12, further comprising:
independently controlling each of the first hydraulic pump and the second hydraulic pump so that a combined hydraulic power output satisfies 100% of a hydraulic power output demand for the electric mining machine.

14. The method according to claim 13, further comprising:
increasing or decreasing a hydraulic power output from one of the first hydraulic pump or the second hydraulic pump to balance an amount of charge of one of the first battery pack or the second battery pack.

15. The method according to claim 12, wherein upon an occurrence of a failure event associated with one of the first hydraulic pump and the second hydraulic pump, the method further comprises:
operating the remaining one of the first hydraulic pump and the second hydraulic pump at its maximum hydraulic output to maintain operation of the electric mining machine.

16. The method according to claim 9, wherein the electric mining machine is configured to operate using only the maximum hydraulic power output from one hydraulic pump of the pair of hydraulic pumps.

17. The method according to claim 16, wherein the electric mining machine includes a steering system; and
wherein the maximum hydraulic power output from the one hydraulic pump of the pair of hydraulic pumps is sufficient to control the steering system.

18. An electric mining machine comprising:
a first pump motor configured to drive a first hydraulic pump of the electric mining machine;
a second pump motor configured to drive a second hydraulic pump of the electric mining machine;
a first battery pack configured to supply electric power to the first pump motor;
a second battery pack configured to supply electric power to the second pump motor; and
a hydraulic control system in communication with at least the first battery pack, the first pump motor, the first hydraulic pump, the second battery pack, the second pump motor, and the second hydraulic pump, wherein the hydraulic control system is configured to:
independently control each of the first hydraulic pump and the second hydraulic pump so that a combined hydraulic power output satisfies 100% of a hydraulic power output demand for the electric mining machine.

19. The electric mining machine according to claim 18, wherein each of the first hydraulic pump and the second hydraulic pump has a maximum hydraulic output that provides more than 50% of a maximum total hydraulic power requirement for the electric mining machine such that a combined hydraulic power output of the first hydraulic pump and the second hydraulic pump is more than 100% of the maximum total hydraulic power requirement.

20. The electric mining machine according to claim 18, wherein the hydraulic control system is further configured to:
compare a state of charge of the first battery pack to a state of charge of the second battery pack; and
upon determining that the state of charge of the second battery pack is greater than the state of charge of the first battery pack, increase a hydraulic power output of the second hydraulic pump and/or decrease a hydraulic power output of the first hydraulic pump of the electric mining machine to balance the state of charge of the second battery pack with the state of charge of the first battery pack.
